(19) United States
(12) Patent Application Publication
(10) Pub. No.: US 2009/0013263 A1
(43) Pub. Date: Jan. 8, 2009

(54) METHOD AND APPARATUS FOR SELECTING EVENTS TO BE DISPLAYED AT VIRTUAL VENUES AND SOCIAL NETWORKING

(76) Inventors: Matthew Jonathan Fortnow, New York, NY (US); Stephen Oriel Newman, New York, NY (US)

Correspondence Address: Thomas F. Presson, Esq.;c/o FROMMER LAWRENCE & HAUG LLP, 745 Fifth Avenue, New York, NY, 10151, US

(21) Appl. No.: 12/139,736

(22) Filed: Jun. 16, 2008

Related U.S. Application Data
(60) Provisional application No. 60/936,612, filed on Jun. 21, 2007.

(51) Int. Cl. G06F 3/048

(52) U.S. Cl. 715/753

(57) ABSTRACT

A system and method for creating a social entertainment network that allows remote viewers to simulate and participate in the energy and social interaction associated with attendance at a live event. Audio and video content is streamed from events as they occur into virtual venues where people represented by avatars can interact with each other. Users can also establish private virtual venues for viewing live events and/or pre-recorded events.

### CROSS REFERENCE TO RELATED APPLICATIONS

This application claims the benefit of prior provisional application Ser. No. 60/936,612 filed on Jun. 21, 2007, which is hereby incorporated by reference in its entirety herein.

### BACKGROUND

1. Field of the Invention

This invention relates generally to a method and apparatus for accessing entertainment content and viewing the content. More particularly, the present invention is directed to viewing entertainment content at a virtual interactive venue that permits users to assume a virtual identity and interact with other virtual identities.

2. Background Discussion

Typical conventional content-driven Internet websites provide viewer access to entertainment events from around the world. A user at a remote location can access an audiovisual event for viewing alone or with a small group. Through a streaming Internet connection, the event can essentially be viewed live, very much like watching a live televised broadcast of the event.

For a remote viewer, an online audiovisual event lacks the energy and viewer interaction normally associated with being present at the live event. A solitary viewer, even with a few other viewers present, would not experience the group dynamic and the excitement of attending the live event. Such viewers are isolated from the event physically and psychologically. The social interaction is limited to those viewing the event at a single remote location, and interaction with others at the event is lacking. This lack of social interaction prevents a user from sharing the experience with other attendees and enjoying the benefits of the dynamic atmosphere of a live performance.

Attendance at a live event necessarily requires that all viewers are present at the same location at the same time. Even though an Internet-based network allows multiple remote viewers to view an event occurring at a foreign location, such that an event in one city can be viewed by participants in that city, in a distant city, or in a distant country, there is no ability for the viewer to interact with other viewers at the event.

Therefore, it would be an advancement in the state of the art to provide a system and method that allows remote viewers of an event to interact with other viewers as if they were all present at the event.

### SUMMARY

Thus, the present invention is directed to a system and method for creating a social entertainment network that allows remote viewers to view a live event in real time and simulate the energy and social interaction associated with attendance at a live event. Also, the viewer may select archived event data and enjoy social interaction, via a virtual identity, with others viewing the archived event data.

Accordingly, one embodiment of the present invention is directed to a method for selecting an event and displaying it at a selected virtual venue during the duration of the event (“the method”). Viewers of the event establish associated virtual identities at the virtual venue and interact with others viewing the event at the selected venue.

Another embodiment of the present invention is directed to the method described above wherein the virtual venue is available to other virtual identities associated with other users.

Yet another embodiment of the present invention is directed to the method described above and also includes selecting a second event and displaying it at a second virtual venue. The second event may be displayed during the duration of the second event, or may be pre-recorded.

Yet another embodiment of the present invention is directed to the method described above wherein each viewer present at an event, as represented by an associated virtual identity, and meeting certain attendance criteria is credited with a virtual confirmation of presence at the event.

Yet another embodiment of the present invention is directed to the method described above wherein each viewer present at an event, as represented by an associated virtual identity, receives a virtual data card related to the event viewed. Yet another embodiment of the present invention is directed to the method described above wherein each user can select and display archived events and corresponding data.

Yet another embodiment of the present invention is directed to the method described above wherein each user can create limited customized collections of archived events and corresponding data for retrieval at any time in a personal virtual venue.

Yet another embodiment of the present invention is directed to the method described above in which additional users, represented by associated virtual identities, are invited to visit the selected virtual venue. The invitation may be via an email directed to a particular or selected user, or may be an electronic message posted to a server and retrieved, or accessed, by a user.

Yet another embodiment of the present invention is directed to the method described above in which each additional user can invite other users, each represented by an associated virtual identity, to visit the virtual venues. Access to the virtual venues can be subject to authorization and limits on the number of virtual identities in the virtual venue.

Yet another embodiment of the present invention is directed to the method described above wherein users, represented by associated virtual identities, can review and purchase archived events and associated virtual or real merchandise.

Yet another embodiment of the present invention is directed to the method described above wherein each user can transmit rating data on the event viewed. The accumulated rating data may be displayed at the virtual venue during the duration of the event.

Yet another embodiment of the present invention is directed to the method described above wherein certain collected rating data can be used to determine periodic ranking of events, segments of events, performers, or venues which may be based on specific criteria.

Yet another embodiment of the present invention is directed to the method described above wherein virtual venues can be customized by the user to include particular characteristics.

Other embodiments of the present invention include the methods described above in which events subsequent to the second event can be selected, accessed and displayed at the selected virtual venue. Also, the present invention may be implemented as an apparatus, or using software, hardware, or a combination of software and hardware. The present invention may also be stored on a computer-readable medium and downloaded from a remote storage location.

Yet another embodiment of the present invention is directed to a virtual tipping feature, which replicates tipping in an actual social club environment. For example, when a band plays in a venue, the band may pass around a hat (or bucket), and people can tip the band a desired amount of money. Tipping is a way of saying thanks and that a patron enjoyed the show. Similarly, in virtual rooms of the present invention, there is an option to tip the band being viewed. The amount of the tip will be deducted from the credits in a viewer's account, or a viewer making a tip will be asked to purchase more credits if the viewer has insufficient credits. The tipping amount will be totally anonymous to others, so no other users will know if or how much any other user is tipping. However, the band can access a list of which users tipped them, and the amount of the tip.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed, and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a network environment adapted to support embodiments of the present invention;

FIG. 2 illustrates a block diagram example of a processing device shown in FIG. 1;

FIG. 3 illustrates a flow chart of one embodiment of the present invention;

FIG. 4 illustrates a block diagram example of a server apparatus as shown in FIG. 1;

FIG. 5 shows an example of event data times and locations;

FIG. 6 shows an example of a user interface that provides categories of events according to the present invention;

FIG. 7 shows an example of a user interface that provides music choices according to the present invention;

FIG. 8 shows an example of a user interface that enables a user to purchase merchandise according to the present invention;

FIG. 9 shows an example of a public virtual venue according to the present invention;

FIG. 10 shows another example of a public virtual venue according to the present invention;

FIG. 11 shows an example of a private virtual venue according to the present invention;

FIG. 12 shows an example of a backstage virtual environment according to the present invention;

FIG. 13 shows a user interface that permits a user to select an associated virtual identity according to the present invention;

FIG. 14 shows a user interface to enable a user to edit content and data according to the present invention;

FIG. 15 shows an algorithm to access and provide content data from a server apparatus;

FIG. 16 shows an example of avatars interacting in a virtual environment while an event is occurring;

FIG. 17 shows another example of avatars interacting in a virtual environment while an event is occurring; and

FIG. 18 shows an example of users represented by real time video footage interacting while an event is occurring.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from, and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As stated previously, the present invention is directed to a system and method for creating a social entertainment network that allows remote viewers to simulate and participate in the energy and social interaction associated with attendance at a live event. The live event is selected from a list, or menu of possible events that are occurring in real time. The live event menu is compiled by obtaining scheduling data from many live event venues and generating a schedule from accumulated data. Typically, the accumulated data related to event content and times is accessed and processed at a central location that then streams or downloads a particular event upon request from a user.

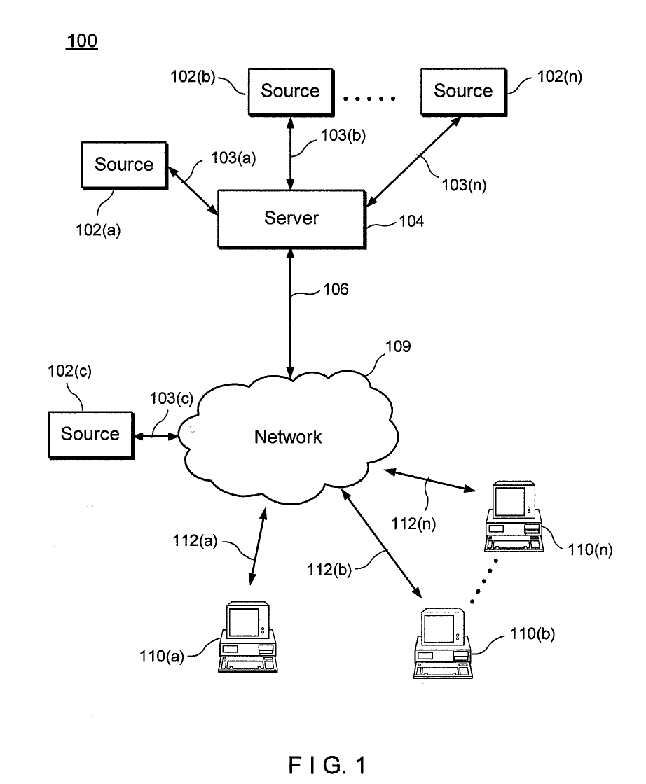

An example is described in a network environment. Specifically, FIG. 1 shows a network environment 100 adapted to support the present invention. The exemplary environment 100 includes a network 109, a plurality of content sources 102(a) . . . (n) (where “n” is any suitable number), a server apparatus 104, and a plurality of processing devices, or client terminals, 110(a) . . . (n) (where “n” is any suitable number). The processing devices 110 may be integral to a display device, in which case they may be deemed display processing modules that control a graphical user interface (GUI) of the display device. Alternatively, the processing devices 110 may be disposed in a separate housing and be operatively coupled to a display device. The processing devices 110 may request data from the server 104 through the network 109.

The network 109 is, for example, any combination of linked computers, or processing devices, adapted to transfer (transmit and/or receive) and process data. The network 109 may include wireless and wired transmission capabilities. The network 109 may be a private internet protocol (IP) network, as well as a public IP network, such as the Internet that can utilize World Wide Web (www) browsing functionality. Alternatively, the network 109 may be an Ethernet network, or any two or more operatively coupled processing devices that can share information. An example of a wired network is a network that uses communication busses and MODEMS, or digital subscription lines (DSL), or a local area network (LAN), or a wide area network (WAN) to transmit and receive data between the processing devices 110 and the server 104. An example of a wireless network is a wireless LAN. Global System for Mobile Communication (GSM) is another example of a wireless network. The GSM network is divided into three major systems which are the switching system, the base system, and the operation and support system. Also IEEE 802.11 (Wi-Fi) is a commonly used wireless network in computer systems, which enables connections to the Internet or other machines which have Wi-Fi functionality. Wi-Fi networks broadcast radio waves that can be picked up by Wi-Fi receivers that are attached to different computers.

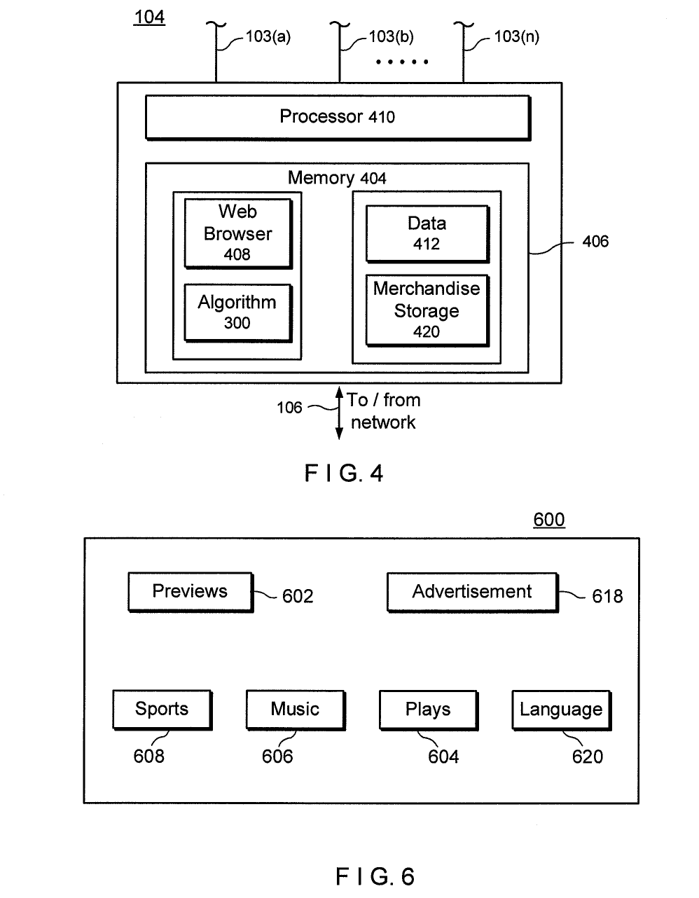

Server apparatus, or device 104 is, for example one or more computer processing devices each with electronic memory and processing capability (generally referred to as server device 104). Server device 104 is typically dedicated to server functionality and is operatively connected to sources 102(a) . . . 102(n)(where “n” is any suitable number) via a corresponding bi-directional wired or wireless communication link 103(a) . . . (n). Server apparatus 104 is operatively connected to network 109 via a bi-directional wired or wireless communication link 106. The server apparatus 104 is operable to receive, store, process, and transmit data to and from content sources 102. Server apparatus 104 is also operable to receive, store, process, and transmit data to and from the network 109 via communication link 106. Server device 104 may also store and/or access archived video data that may be compressed or otherwise stored on server device 104. The server 104 may access stored or archived data from a remote location, such as a remote storage location and store the data in memory at server apparatus 104. Server apparatus 104 is described in greater detail in relation to FIG. 4.

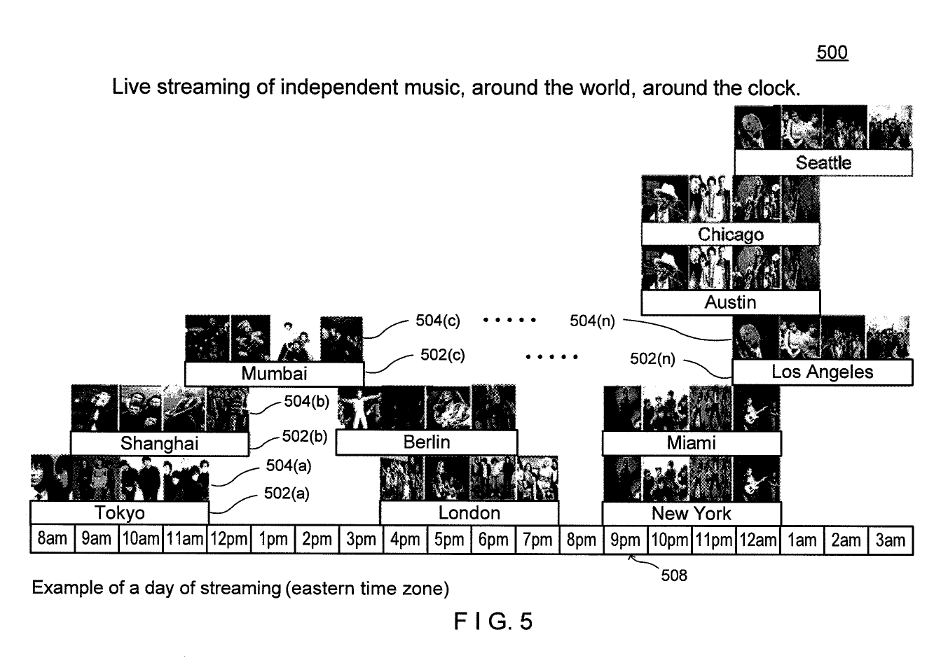

Sources 102 are typically any source of electronic content, which may be archived content data or live content data, such as performances, concerts, sporting events, or other entertainment events, and provided to server apparatus 104. The sources 102 may be one or more video cameras, web cameras, electronic storage medium, broadcast signal, radio signal or any media that can transmit electronic data, such as audio and/or video data to server apparatus 104. In the instance of a live performance, such as a live concert, educational classes, or sporting event, such as a football game, soccer game, boxing match etc. the content data can be uploaded as it is happening (real time) and transmitted to server 104 such that the server 104 can provide the content data to one or more processing devices, or client terminals, 110. For example, a camera located at the venue at which the event is taking place can record and upload the content to the server 104, which will then distribute the content to selected client terminals 110. Specifically, a live performance could be captured via an audio video recording device, which transmits the content to server device 104, which server 104 transmits to selected client terminals 110 while the performance is occurring (i.e., in real time). The server apparatus 104 is configured to receive content from any one of sources 102 and can access content data from multiple sources 102 simultaneously. The timing sequence of content provided by sources 102 is described in more detail in relation to FIG. 5.

Also, when the electronic content is archived data, or a pre-recorded event, the electronic content data may be transmitted to a repository location, or buffer, or storage medium (not shown) and subsequently transmitted to server 104.

Client terminals, or processing devices, or appliances 110 are, for example, a PC (personal computer) laptop computer, electronic tablet, handheld PDA, mobile telephone, pocket computer, palmtop computer, or any electronic device that has web browsing and/or Internet capability (connectivity capability) and display and memory capability. Processing devices 110 are operatively connected to network 109 via an associated bi-directional wired or wireless communication link 112(a) . . . (n). Processing devices 110 are operable to receive one or more data streams from source 102 through the server apparatus 104 and the network 109. Processing devices 110 are also operable to transmit data to server apparatus 104 through network 109.

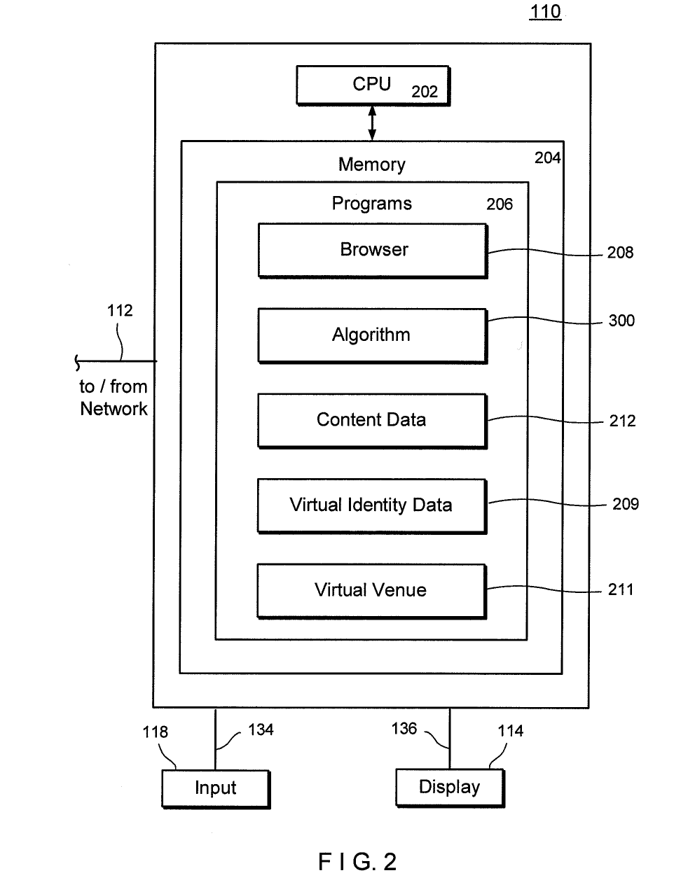

FIG. 2 illustrates an example of a processing device, or client terminal, 110 that is adapted to receive, store, manipulate, process, and transmit data related to the present invention. The processing device 110 includes a display unit 114, an input module 118, a CPU 202 and a memory module 204.

Image display unit, or module, 114 is coupled to processor unit 110 via bidirectional communication medium 136, which is typically a bus or wired connection. The display unit 114 is used to display the content data generated by the sources 102 and provided by server apparatus 104 (shown in FIG. 1). The display unit 114 may be, for example, a monitor, LCD (liquid crystal display), a plasma screen, a graphical user interface (GUI) or other module adapted to display output data typically by a representation of pixels.

Input module 118 is coupled to processing unit 110 via bidirectional communication medium 134, which is typically a bus or wired connection. The input module 118 may include devices such as a keyboard, mouse, track ball and/or touch pad or any combination thereof.

The CPU 202 is typically a processor that includes an arithmetic logic unit (ALU), which performs arithmetic and logical operations, and a control unit (CU), which extracts instructions from memory and decodes and executes them, utilizing the ALU when necessary.

Memory module 204 is typically an electronic storage medium such as RAM, ROM, EEPROM or other memory device, such as an optical disk, optical tape, CD, or a floppy disk, a hard disk, memory stick, thumb drive, or a removable cartridge, which may be inserted into a port (e.g., a USB port) or interconnector, on which digital information is stored in the form of bits. It may also include recorders to record to and read from mass storage devices such as, for example, optical disks, magnetic disks, flash semiconductor disks, and other types of storage which may be temporary or permanent.

The memory module 204 stores programs 206, which include, for example, a web browser module 208, algorithm module 300, content data module 212, virtual identity data module 209 and virtual venue module 211, as well as typical operating system programs (not shown), input/output programs (not shown), and other programs that facilitate operation of processing device, or client terminal, 110. Some or all of the programs 206 may be stored in a memory module on server 104 (FIG. 4).

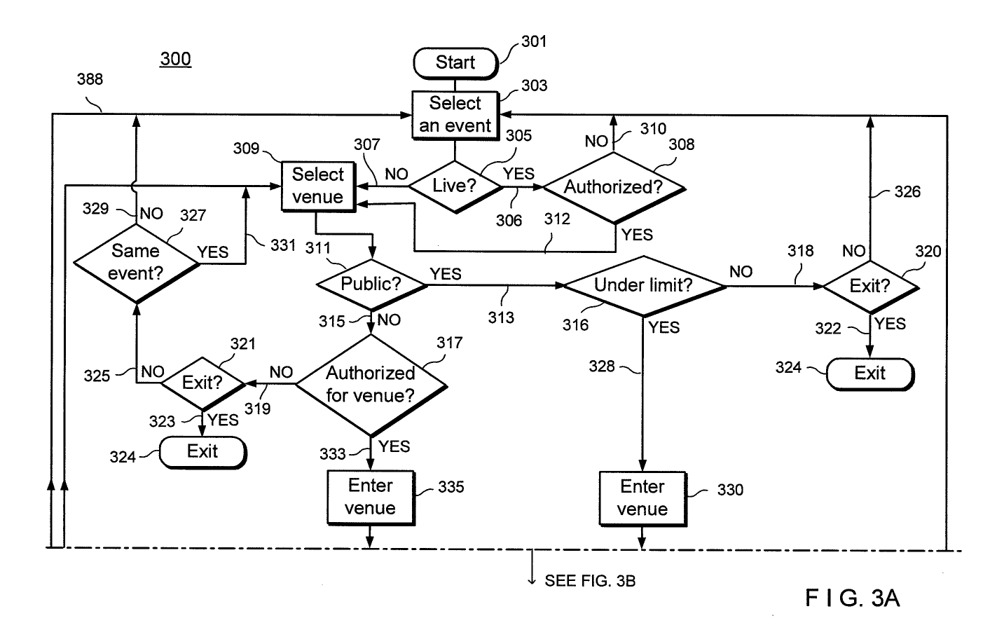

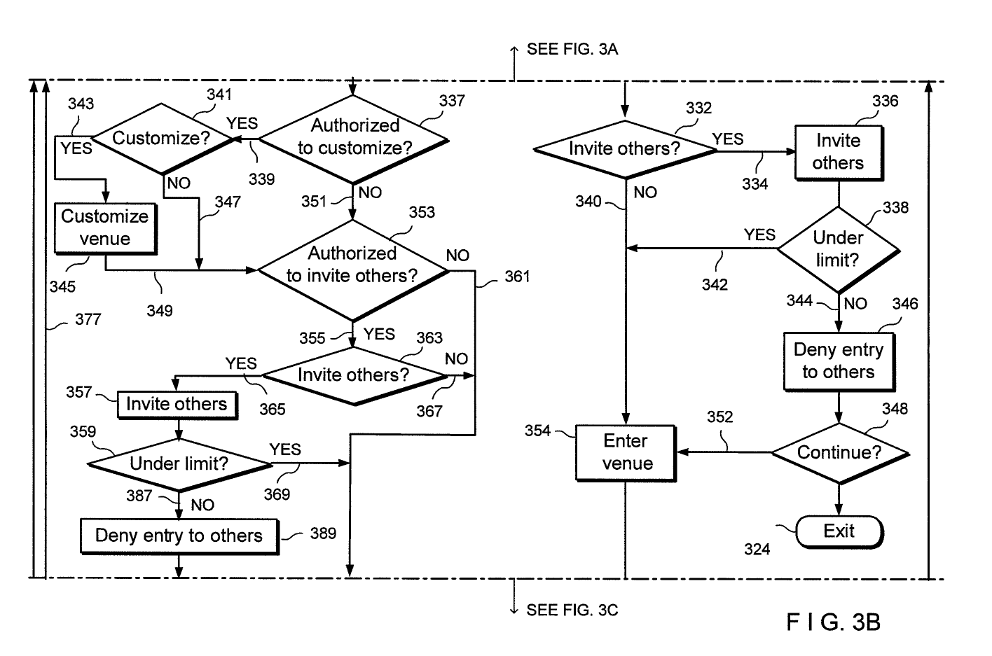

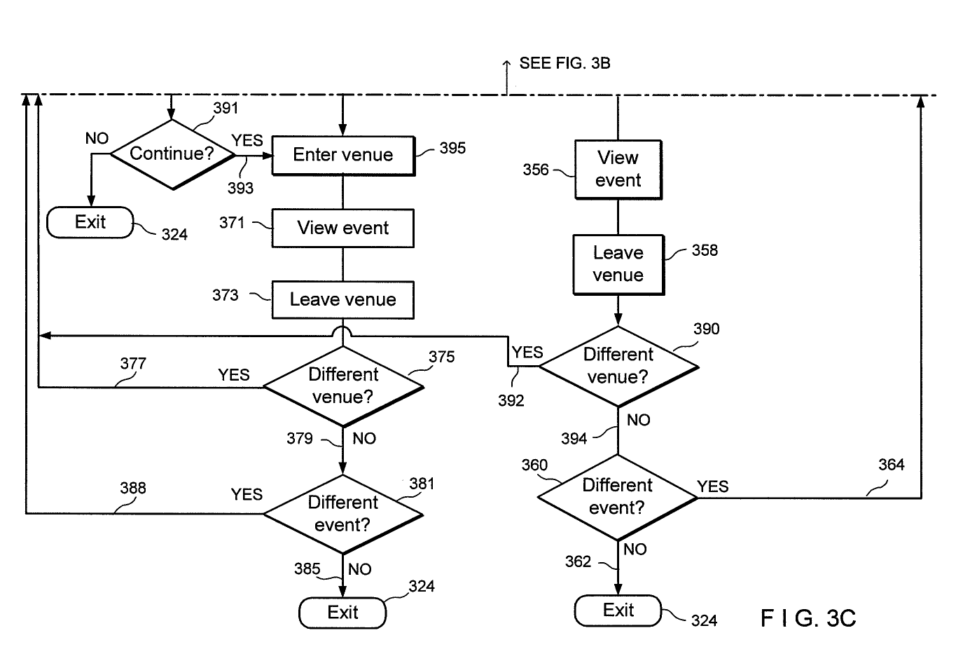

Web browser module 208 stores a web browser program that is, for example, an Internet browser program such as Internet Explorer™. Algorithm storage module 300 stores an algorithm, which is a series of steps for accessing, manipulating, and/or processing selected data, which is typically stored in a computer-readable memory. Algorithm 300 is discussed in more detail in relation to FIG. 3. Content data storage module 212 may store content data received from one or more sources 102. Virtual identity module 209 may store a user's associated virtual identity, or avatar that is selected by the user. Virtual venue module 211 may store information related to user's private virtual venue or a public virtual venue, which is described in more detail herein.

As shown in FIG. 3, algorithm 300 is a series of steps, typically stored on a computer-readable medium that may be executed by a processing device to implement an embodiment of the present invention. The algorithm 300 may be stored on any suitable electronic medium, such as RAM, ROM, EEPROM or other memory device, such as an optical disk, optical tape, CD, or a floppy disk, a hard disk, memory stick, thumb drive, or a removable cartridge. The algorithm 300 may be stored on an electronic medium, and the CPU, when executing the program code of the algorithm, is a processing module adapted to perform the recited functionality.

As shown in FIG. 3, step 301 begins execution of the algorithm. A user may log onto a website supported by a content provider (described as server 104 in combination with source 102), or otherwise access content data, typically via an associated client terminal (110 in FIG. 1) and selects content data or an event, as shown in step 303. The content is for example, a live concert, sporting event, or archived data from a list provided. The event selected is analyzed for the temporal nature of the event, and a determination is made whether the selected content is live streaming data or archived data, as shown in decision step 305, which determines whether the event is occurring in real time (“live”) or is archived.

If the event is live (i.e., occurring in real time), line 306 leads to step 308 which determines whether the user is authorized to receive the content. The authorization could be based on a subscription, user fee, password, age, nature of the content selected, or other acceptable criteria. If the user is not authorized to access the content, the user is returned to step 303 via “no” line 310 to select another event. If authorization is found in step 308, “yes” line 312 leads the user to select a venue, as shown in step 309. The venue may be a virtual venue, which is, for example, a representation of any typical place from which such events occur, for example a club, coffee shop or theater or even unusual locales, such as an ice cave, the Martian surface or the top of a cloud. Displayed inside the virtual venue is a video stream from the actual venue at which the event is occurring. This is achieved by having cameras and microphones at the actual venue that provide video and audio data of the event. The virtual venue could also be a representation, or facsimile of, the coliseum, hall, outdoor stage, stadium, sports arena, or location of the event, generated from the video footage or computer graphics. A public venue is any venue a user can enter. The public venue could be created using software or could represent an actual physical location (e.g., Central Park in New York City). Thus, a user may select an event and then pick a venue.

The user may be represented at the virtual venue as a virtual identity. This virtual identity may be an avatar, animated character, real time video footage of, or other electronic representation of the person. The electronic representation is typically a graphical image with personal features and clothing. Each user may designate or select an associated virtual identity that they may change or maintain when they visit additional virtual venues, or at any time. Also, the virtual identity appearance may be modified by changing clothing or personal accessories. For example, a user may wear sunglasses, change their shirt, change their coat, shoes, etc. Thus, the virtual identity identifies a user at a virtual venue. Decision step 311 determines whether the venue is public, and if so, “yes” line 313 leads to step 316.

In step 316 a comparison of a pre-selected population limit of the virtual venue to the population is made. This population is based on the number of virtual representations (avatars) and/or actual people attending the event at the venue. This enables a user, via an associated avatar to experience the “feel” of actually being present at a venue. If the limit is exceeded, line 318 directs the user to an option, illustrated by step 320, to choose exit step 324 as shown by line 322 or selecting an alternate event as shown by line 326 leading to step 303. This feature provides a user with a real-life experience of attending the event remotely, since if the event is full to capacity the user will not be admitted, similar to an actual attempt to attend a “sold out” show. If the limit check of step 316 indicates the pre-selected population limit has not been exceeded, the user is allowed to enter the virtual venue, as shown in step 330, via line 328.

Once in the virtual venue, as shown in step 330, the user may choose to invite other users to the virtual venue, as illustrated in step 332. The invitation may be an email to the invitee, or an open invitation posted on a website or list of users. If other users are to be invited, line 334 leads to step 336 in which other users can be invited to the venue. The population of the venue is compared to the pre-selected limit at step 338. If the limit has been reached, line 344 leads to the denial of entry to the other users, as shown in step 346. The user is given the option in step 348 to continue along line 352 and enter the venue at step 354, or to exit at step 324. This replicates the actual experience of a group of people attempting to enter a “sold out” venue. When the entire group, as represented by avatars, or other electronic representation, cannot be admitted, the entire group may prefer to go elsewhere.

If in step 338, the pre-selected limit has not been reached, the other users may enter the venue in step 354 and the event can be viewed, as shown in step 356. At any time, the user, as well as the other users who were invited, may leave the venue, as shown in step 358. Step 390 allows a different venue to be selected. If an alternate venue is chosen, “yes” line 392 returns the user to step 309, in which the user may select a venue. The steps are followed in the same order as recited above.

If a user does not choose in step 390 to select an alternate venue, “no” line 394 leads to step 360, which allows an alternate event to be selected. If an alternate event is chosen, line 364 leads to step 303, in which the user may select an event. This feature simulates a situation in which a person goes to a venue, such as a restaurant and then chooses to go elsewhere. When another selection is made, as shown in step 303, the steps are followed as recited above. If in step 360, a user does not wish to select a new event, “no” line 362 shows that the user is exited at step 324.

If the event selected in step 305 is archived (not a live event), such as a stored video, pre-recorded concert, pre-recorded sporting event, the user may select a virtual venue to view the archived event, as shown in step 309, via line 307. Step 311 shows that the nature of the selected virtual venue is determined, that is whether it is a public virtual venue or a private virtual venue. If the virtual venue is public, the user is directed to step 316, via line 313 and the steps recited above are performed. Typically, an archived event will be displayed at a private virtual venue. Users may purchase or be awarded private virtual venues, which may be used as locations to view live events and/or archived events.

If the virtual venue chosen is not public (i.e., it is a private virtual venue), “no” line 315 shows that the user is queried, as shown in step 317, for authorization to be present at the private virtual venue. The private virtual venue typically has limited access to only users who are invited, and visitors may be denied entry if they are uninvited or unwanted. This private virtual venue has the attributes of actual private property, thereby providing an experience similar to attending a private party or gathering. For example, the private virtual venue may represent a person's home, private club, hall or other venue that is reserved for personal use.

If the user is not authorized, line 319 leads to step 321, which shows that the user is offered the option to exit the venue selection process, as shown by line 323, leading to exit step 324. In the alternative, if the user chooses not to exit, line 325 leads to step 327, which offers the user the same event or an alternate event. If the same event is chosen, the user is prompted for a venue, as shown by line 331 leading to step 309. The steps are then followed as recited above. If an alternate event is chosen, as shown in step 327, line 329 leads to step 303, which enables a user to select an event.

If authorization was found in step 317, line 333 shows that the user would be admitted to the venue, as shown in step 335. Once in the venue, step 337 queries for authorization to customize the private virtual venue. Typically only the user who purchases or buys the private virtual venue is authorized to customize it. If authorization is found, the user is given the option to customize the virtual venue, as shown in step 341, via line 339. If the option to customize the virtual venue is elected, line 343 leads to step 345, which permits the user to customize the venue. This may include furnishing the virtual venue with virtual furniture, decorations, and art of the user's choice and may reflect their personal tastes and preferences. Line 349 then leads to step 353, which determines whether the user is authorized to invite other virtual identities to the private virtual venue.

If the option to customize the virtual venue in step 341 is not exercised, “no” line 347 also leads to step 353.

As stated previously, step 353 determines whether the user is authorized to invite other users to the private virtual venue. If authorization is granted, “yes” line 355 leads to step 363, where the user may choose to invite other users to the virtual venue. The invitation may be an email to the invitee, or an open invitation posted on a website or list of users. If other users are to be invited, line 365 leads to step 357 in which other users can be invited to the venue. The population of the venue is compared to the pre-selected limit at step 359. If the limit has been reached, line 387 leads to the denial of entry to the other users, as shown in step 389. The user is given the option in step 391 to continue along line 393 and enter the venue at step 395, or to exit at step 324. This replicates the actual experience of a group of people attempting to enter a “sold out” venue. When the entire group, as represented by avatars, or other electronic representation, cannot be admitted, the entire group may prefer to go elsewhere.

If in step 359, the pre-selected limit has not been reached, the other users may enter the venue in step 395 and the event can be viewed, as shown in step 371. At any time, the user, as well as the other users who were invited, may leave the venue, as shown in step 373. Step 375 allows a different venue to be selected. If an alternate venue is chosen, “yes” line 377 returns the user to step 309, in which the user may select a venue. The steps are followed in the same order as recited above.

If a user does not choose in step 375 to select an alternate venue, “no” line 379 leads to step 381, which allows an alternate event to be selected. If an alternate event is chosen, line 388 leads to step 303, in which the user may select an event. This feature simulates a situation in which a person goes to a venue, such as a restaurant and then chooses to go elsewhere. When another selection is made, as shown in step 303, the steps are followed as recited above. If in step 381, a user does not wish to select a new event, “no” line 385 shows that the user is exited at step 324.

FIG. 4 illustrates an example of a server apparatus 104 that is adapted to receive, store, manipulate, process, and transmit data related to the present invention. The server apparatus 104 typically stores all data, such as archive data, virtual identity data, venue data etc., as shown by data storage module 412. Merchandise storage module 420 is used to store merchandise data. The server apparatus 104 may respond to requests from the processing devices, or client terminals (shown as element 110 in FIG. 1) via interconnector 106 to a network (shown as element 109 in FIG. 1). The server apparatus 104 may also receive content data from sources, via interconnector 106 or interconnectors 103(a) . . . (n). The interconnectors 106 and 103 represent data paths, which may or may not use a common bus or medium.

Memory module 404 is typically an electronic storage medium such as RAM, ROM, EEPROM, or other memory device, such as an optical disk, optical tape, CD, or a floppy disk, hard drive, portable memory stick that can be inserted into a port (such as a USB port) or other communications connector, or a removable cartridge, on which information is stored. The memory module 404 may also store program storage module 406, which includes, for example, a web browser module 408, a data storage module 412, merchandise storage module 420, an algorithm storage module 300, as well as typical operating system programs (not shown), input/output programs (not shown), and other programs that facilitate operation of server 104.

Web browser module 408 stores a web browser program that is, for example, an Internet browser program such as Internet Explorer™. Data storage module 412 stores data files, for example video files, related to the present invention. Algorithm storage module 300 stores an algorithm, which is a series of steps for accessing, manipulating, and/or processing selected data, which is typically stored in a computer-readable memory and executed by the processor 410.

Processor 410, which is operatively connected to memory module 404 is used to process, store, and manipulate data received from sources 102 and from processing devices 110.

FIG. 5 shows an example 500 of event data times and locations. A schedule, as shown in FIG. 5, may be available for each type of content data available, as shown in FIG. 6. Thus, when a user selects “classic rock” music, a graphical depiction 500 provides the user with a timetable and location indicator for classic rock performances.

One embodiment of the invention is that live streaming will be available virtually continuously, from venues located around the world. As opposed to ad hoc events from time to time, the invention creates in essence a live streaming channel, with live streaming of shows available at practically any time of the day. FIG. 5 illustrates an example of the live streaming programming schedule for the U.S. Eastern time zone.

As shown in FIG. 5, a time of day descriptor 508 shows a timeline for performances. Location descriptors 502(a) . . . (n) (where “n” is any suitable number) show locations of content origination. For example, at 8:00 am EST, live streaming content data is available from Tokyo. This content streams from 8:00 am EST until 12:00 pm EST. From 9:00 am EST until 1:00 pm EST, streaming content is available from Shanghai. Thus, as shown in FIG. 5, sources of content from around the world can be accessed such that live streaming audio/video data is continuously provided. Thus, users may choose desired content and view the content at a virtual venue, generated by audio and video data at the actual venue and displayed to users and their associated virtual identities. Graphical information 504(a) . . . (n) (where “n” is any suitable number) provides a graphical representation of performers and/or events, such as concerts.

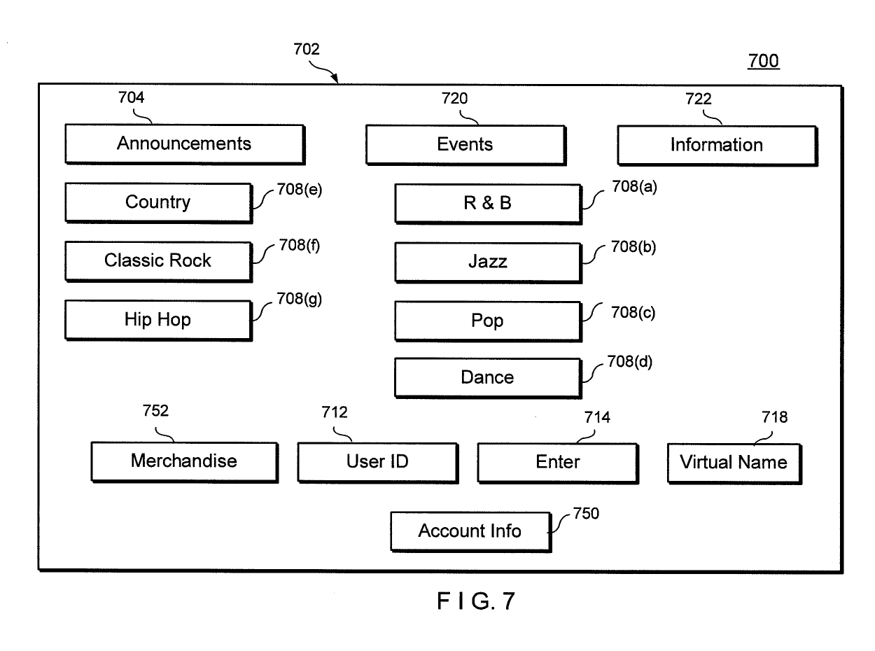

FIG. 6 shows an example of a data display or user interface 600 that provides categories of events that a user may select, previews, advertisements, or information concerning participating real (physical) venues. The display or interface 600 may be displayed as a screenshot or webpage at the display unit of a client terminal. As shown in FIG. 6, display 600 has menu buttons, or selection keys, 608 (sports), 606 (music), 604 (theater/plays) that permit a user to select desired content. Once selected, a particular selection will provide additional menu selections relating to the desired content (FIG. 7).

The content may be categorized based on a pre-determined structure. Menu button 620 permits a user to select a preferred language. Area 602 is, for example, a preview section that continuously displays preview data and particular content of upcoming events and information about times and performers. Area 618 may be, for example, an advertisement banner that displays advertising data. This advertising data 618 may advertise virtual merchandise or products for purchase, actual merchandise or products for purchase, real (physical) venue information, event ticket information such as concert ticket sales, and other commercial data.

FIG. 7 shows an example of a display or user interface 700, which may be, for example displayed as a screenshot or webpage at the display unit of a client terminal. The display 700 provides choices for various music genres. This display page or webpage 702 may be the result of a user selecting “music” menu button, shown as 606 in FIG. 6.

The various types of music are shown as 708(a) . . . (g), although more or less selections could be displayed. A user may select one of the music categories based on individual taste or preference. For example, 708(a) provides access to “R&B” music; 708(b) provides access to “jazz” music; 708(c) provides access to pop music and so forth. These may be live shows or archived shows or performances.

Area 704 provides a designated portion of webpage 702 to display announcements, such as show and concert information, information about particular bands and/or featured entertainers. Area 720 provides event information. This could be event information related to a real time event or information about a showing of a previously recorded event. For example if a band is scheduled to perform at 10:00 EST in Chicago, this information could be made available to users who might then select the concert to be displayed on the display unit. The user might also invite other users to attend, via their virtual identities. The posted event data would be similar to a flyer or announcement that a band might post for the actual show, which would be attended by people in Chicago. Also area 722 may be used to provide additional information about a band, or may be used to search for information about a particular band or venue.

Menu button 750 shows that a user can input account information. This information could be a credit card, drivers license information or other identifying or personal information that could be used for verification purposes and/or commercial transactions such as purchasing tickets, purchasing music, purchasing merchandise; both actual and virtual. The account data could also have a credit and debit register to account for payments and purchases of a user. A user may debit the account an amount that the user would like to tip the band, or performer, or group. The amount of the tip would be transferred electronically from the user's account to an account associated with the specified band, performer or group being tipped. The party receiving tip is able to identify the user making the tip and the amount of the tip. In the event the user making a tip has insufficient funds in their account, the user will be asked to purchase more credits.

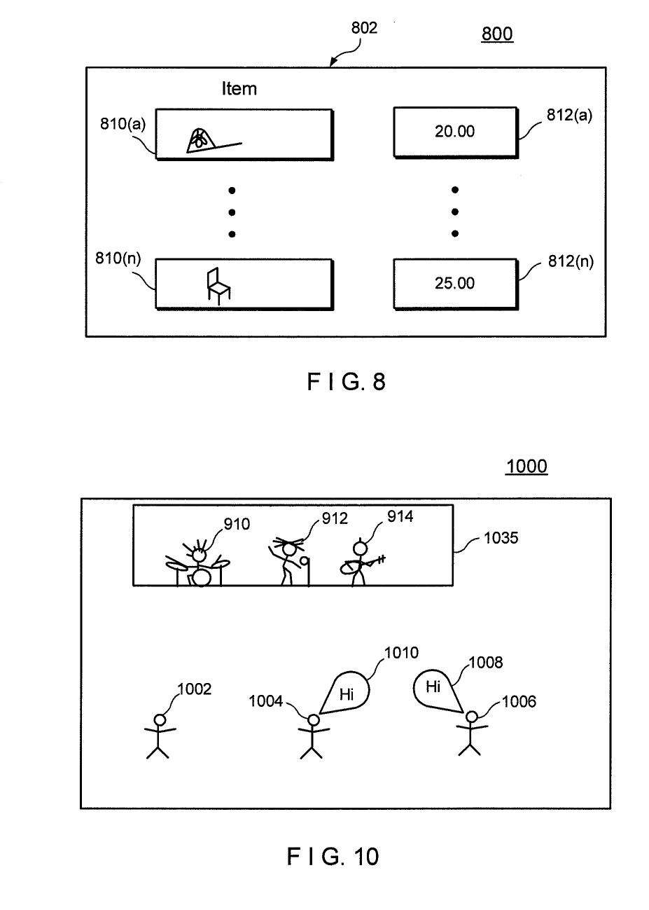

Menu button 752 shows that a user can purchase merchandise from the webpage 702. This merchandise could be actual, such as a hat or T-shirt or could be virtual, such as virtual furnishings for a private virtual venue. The merchandise is described in more detail with reference to FIG. 8.

Button 712 provides a means for a user to enter a user ID. This user ID may be used to entitle a user access to particular content, merchandise, and/or obtaining a user profile to target specific merchandise or entertainment information based on the particular user's tastes or preferences as indicated by previous purchases, downloads, demographic data, such as age, place of residence, income, etc.

Button 718 provides a means for a user to create a virtual identity, including a name and virtual identity, such as an avatar or animated representation or other facsimile of themselves that can interact with other virtual identities of other users.

FIG. 8 shows an example of a display or user interface 800 displayed as a screenshot or webpage at the display unit of a client terminal that enables a user to purchase merchandise. Webpage 802 shows that merchandise 810(a) . . . (n) (where “n” is any suitable number) is offered for sale. A corresponding price 812(a) . . . (n) is also displayed. The merchandise 810 may be actual merchandise and/or virtual merchandise. Actual merchandise includes, for example, T-shirts, hats, clothing that may have a logo or other graphic. Virtual merchandise includes, for example, virtual furnishings for virtual private venues, such as chairs, sofas, lamps, paintings and other decorating items that a user could purchase and put in their virtual venue.

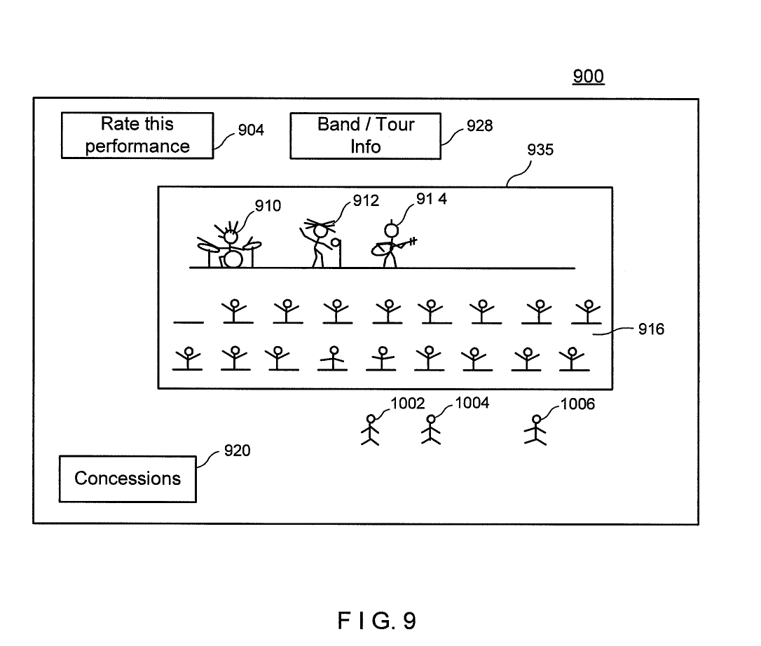

FIG. 9 shows an example of a public virtual venue 900. The virtual venue may be generated by video data taken at a live event, or video data of a pre-recorded event. The frame 935 is, for example, video data from a live event. The video data 935 shows the performers and portions of the audience. The live event may be an event that is selected from a menu of many events that are available in real time. For example, a user may select an event that is occurring in real time in China, or an event that is occurring in real time in Australia. Once the user has selected a particular live event, they can attend the event, via a virtual presence using an avatar or other representation of themselves. The video data is displayed at a client terminal. The virtual venue 900 shows performers 910, 912 and 914 as well as attendees seated in seating section 916 of the actual, live performance. A virtual concession stand 920, enables virtual attendees, or avatars 1002, 1004 and 1010 to purchase virtual food and/or merchandise. The virtual identities, or avatars 1002, 1004 and 1006 are only three examples of virtually any number of virtual attendees. These virtual attendees can interact with each other, as described in more detail in FIG. 10 and thus, simulate the experience of an actual performance for the remote users. Thus, a remote viewer has the ability to interact with other attendees and experience the excitement of the live performance. Menu button 904 provides a remote user to input a rating of the performance indicating whether the user liked or disliked the performance.

Also, menu button 928 may access tour information and/or additional details about the performers that may be of interest to a remote viewer.

FIG. 10 shows another example 1000 of a public virtual venue. In this embodiment, multiple remote viewers are able to interact via virtual identities 1002, 1004, 1006, which each correspond to a user. The virtual identities 1002, 1004 and 1006 are, for example avatars, or animated representations, or facsimiles of the actual people who may be viewing the performers 910, 912 and 914 from locations remote from each other. The performance may be shown as a frame, or stage or other representation 1035. The virtual identities are adapted to interact with each other through actions and words. The actions may be achieved using animation to cause the avatar to move in a desired manner. The words may be achieved through a series of dialogue boxes, shown as text boxes 1010 and 1008 to simulate the experience and fellowship of attending a live event, such as a concert, sporting event, play or similar production. The users may write text messages (chat) to other users that are attending the performance virtually. Distribution of communicated messages through chatting may be limited to a select number of virtual identities, corresponding to a whisper in normal oral communication. This chatting may include a speech capability that will enable users to carry on a conversation, for example using a microphone at the user terminal. The users at other terminals may converse, via microphones at associated user terminals, with each other from remote locations. This chatting may also include video capability combined with speech capability that will enable users to carry on a conversation, for example using a video camera and microphone at the user terminal. The users at other terminals may converse, via video cameras and microphones at associated user terminals, with each other from remote locations. The avatars may interact with each other in a virtual environment that replicates a “real world” interaction. For example, the users, by controlling their associated avatars, may speak to each other, dance with each other, purchase a virtual beer for another avatar, and otherwise interact with other avatars who are present at the virtual venue. Each associated user can control how their avatar acts and what the avatar “says” by controlling the actions and speech of their avatar. The avatars can also arrange to meet at a future time and/or virtual venue (either public or private) by exchanging contact information or other event information that may be of interest. Furthermore, it is also an embodiment of the present invention that a user, via their associated avatar, can refuse to interact or have dialogue with another avatar. This may be accomplished by refusing to accept any spoken or written communication from an undesired avatar.

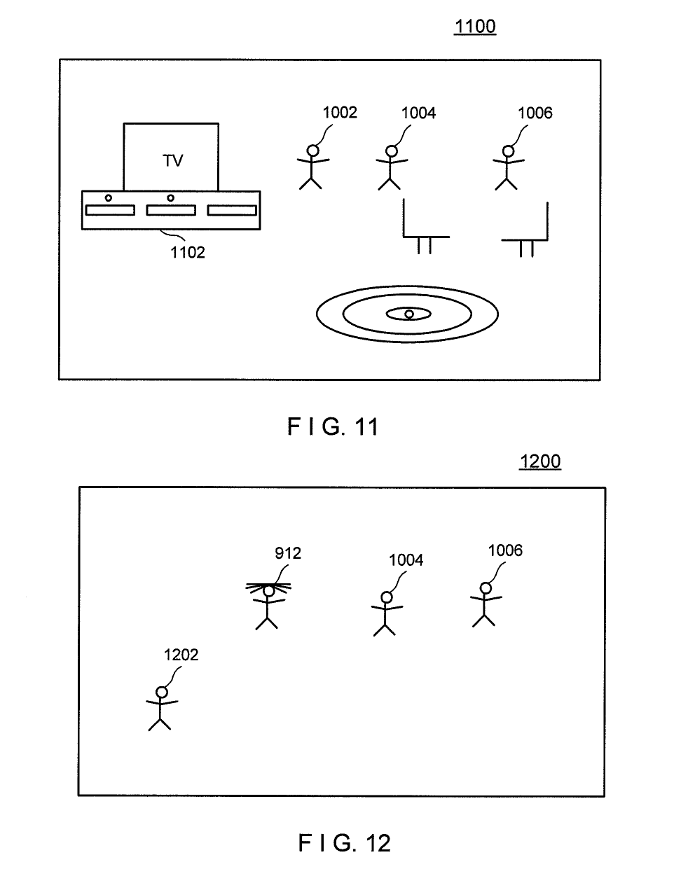

FIG. 11 shows an example of a private virtual venue 1100 according to the present invention. Virtual venue 1100 is created by a user and typically represents a home, backyard, restaurant, sports bar or other virtual space designed by the user. For example, a user could generate a private venue to be a facsimile of their living room in which they wish to entertain the virtual identities of their friends. The virtual venue 1100 may be furnished with virtual decorations, such as a television 1102 and a rug 1104, as described herein. The user, represented by virtual identity 1004 can invite other virtual identities 1002, 1006 to their private virtual venue 1100.

A user who establishes a private virtual venue 1100 can limit access of others to that private virtual venue, thus simulating the experience of having a party in one's house and only allowing invited guests or authorized individuals into your house.

As shown in FIGS. 10 and 11, a user, represented by avatar 1004, can meet a friend, represented by avatar 1006, at a public virtual venue 1000 and subsequently go to the private virtual venue 1100.

FIG. 12 shows an example of a backstage virtual environment 1200. As shown in FIG. 12, virtual identities, or avatars 1004 and 1006 can meet and interact with performers' avatars 912 at the performers' own virtual backstage environment 1200, which is for example, a private virtual venue of the performers. There may also be a moderator 1202.

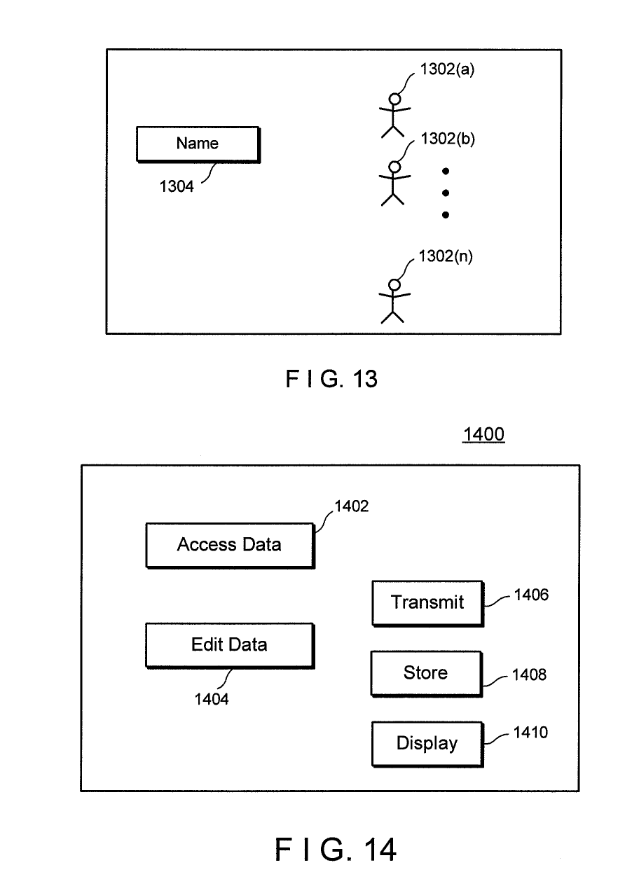

FIG. 13 shows a display or user interface 1300 that may be displayed as a screenshot or webpage at the display unit of a client terminal that permits a user to select an associated virtual identity. This webpage may be accessed as described previously and permits a user to select an avatar 1302(a) . . . (n) (where “n” is any suitable number) to represent the user in virtual venues (both public and private). The user may also select hair color and style, eye color, skin color, clothing and accessories such as hats, shoes, jewelry etc. to dress the avatar. Users can interact and recognize each other through the particular avatar associated with each user. Thus, each user can select and customize an avatar 1302 to represent himself or herself. A user can identify himself or herself with a name or other information, as shown by menu button 1304.

FIG. 14 shows a display, or user interface, 1400 displayed as a screenshot or webpage at the display unit of a client terminal to enable a user to edit content data. Menu button 1402 shows that a user can access content data, which may be live or archived performances or other entertainment data. Once accessed, the user can view it, store it or process it by editing, to create a mix or compilation. Menu button 1404 shows that a user may edit accessed data by deleting portions, adding commentary, or other manipulation. Menu buttons 1406, 1408 and 1410 show that the content data, either edited or unedited may be transmitted (1406), stored (1408) and/or displayed (1410). This user editing feature may be performed offline as well as online.

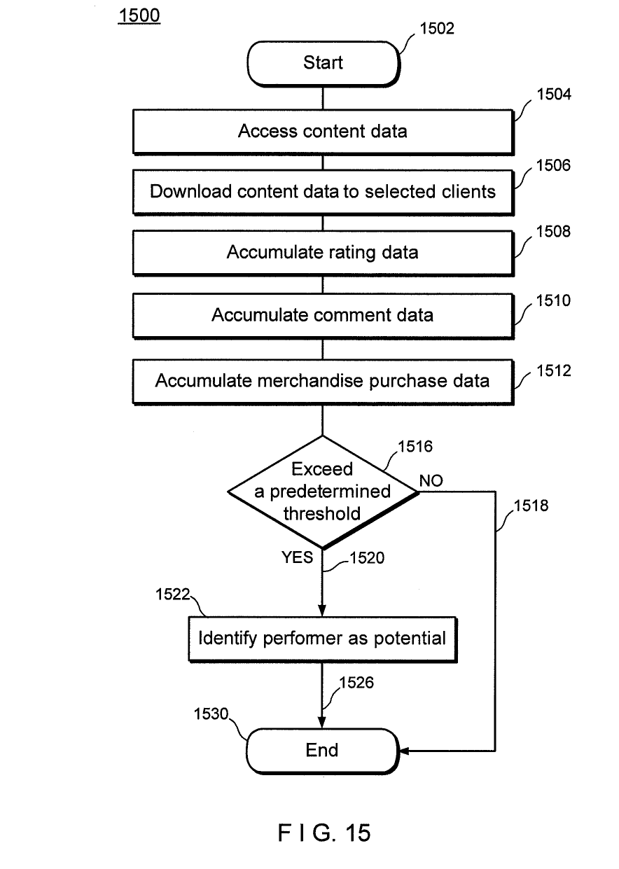

FIG. 15 shows an algorithm 1500 in which a server device accesses content data from a source and provides the content data to client terminals. The algorithm 1500 also enables the server apparatus to accumulate feedback from client terminals and flag or otherwise provide an indication of performers who generate favorable reviews or other comments, or significant merchandise sales, music sales or views of their archived songs and videos.

The algorithm 1500 starts, as shown in step 1502. Content data is accessed by the server apparatus from any one of a plurality of content sources, as shown in step 1504. The content data is downloaded from the server to selected client terminals that are authorized to receive the particular content, as shown in step 1506. As stated herein, the content could be, for example, a music concert, sporting event, play or other real time or archived (pre-recorded) performance. Rating data, obtained from viewers, is accumulated, as shown in step 1508. This rating data may be a numerical quantity input by viewers, such as “one star”, “two and a half stars” or other metric to identify a level of satisfaction with the performance. Comments from viewers may also be accumulated, as shown in step 1510. This comment data may be, for example, written prose expressing an opinion, comments on the type of content, appropriate audience information and other feedback from viewers. Merchandise data may also be accumulated, as shown in step 1512. This data may be the amount of revenue generated from the sale of clothing, CDs, DVDs and other goods related to a performer. It is also an embodiment of the present invention that the number of times a performance is accessed or downloaded is accumulated and the accumulated data may be used to determine popularity of the performer or performance.

Step 1516 shows that a determination is made whether the accumulated rating data, comment data and merchandise purchase data exceeds a predetermined threshold. If so, “yes” line 1520 shows that a flag is set, or other indicator label is generated, to identify the performance as exceeding a minimum popularity threshold, as shown in step 1522. This will facilitate determining whether or not a commercial relationship with the performer may be profitable. While rating data, comment data and merchandise sales are three examples of criteria, or metrics that may be used, other data related to the performer may also be used. Line 1526 shows that end step 1530 is then reached.

If the threshold levels, or other criteria, are not met in step 1516, “no” line 1518 shows that end step 1530 is reached.

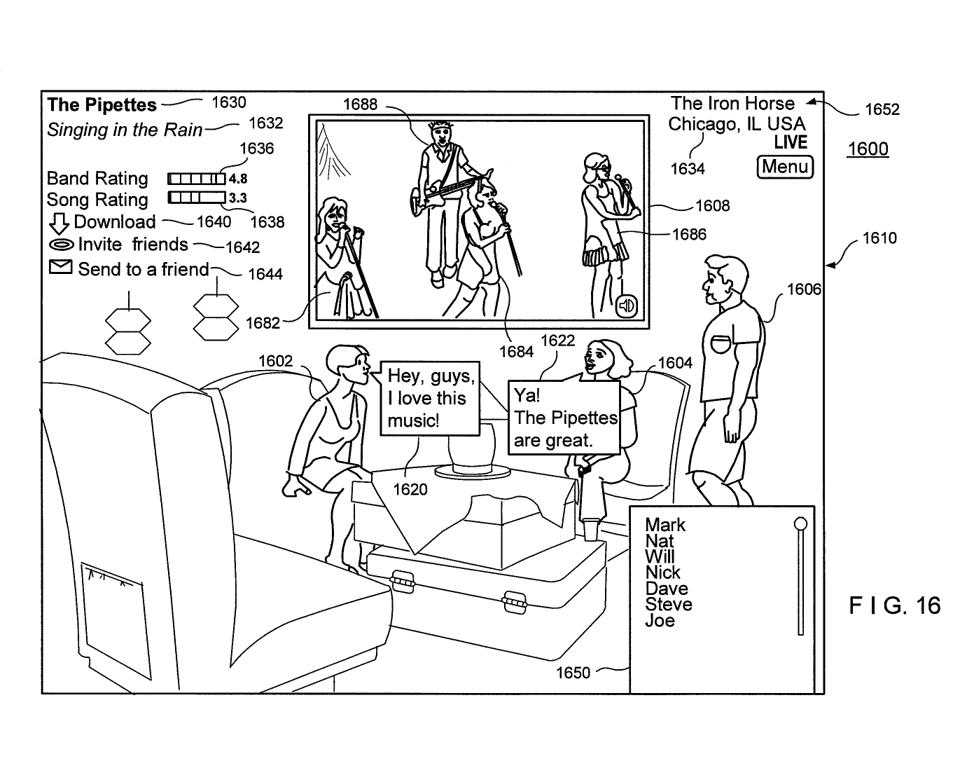

FIG. 16 shows an environment 1600 in which avatars 1602, 1604 and 1606 interact while an event is occurring on screen 1608. The event on screen 1608 has performers 1682, 1684, 1686 and 1688. The performance, which may be a live performance occurring in real time or a selected archived performance, is viewed by a user at a remote terminal, such as their personal computer. Virtual room 1610 provides a virtual place for the avatars 1602, 1604 and 1606 to interact and is furnished with virtual furniture such as tables, chairs, rug and lighting fixtures, which make the virtual room 1610 have a look and feel of an actual room. The avatars 1602 and 1604 are speaking to each other, using text boxes 1620 and 1622, respectively, reflecting a conversation between the users represented by their associated avatars. The music group is identified as “The Pipettes” as shown by element 1630. The title of the song “Singing in the Rain” is shown as element 1632. A band rating and song rating is displayed as 1636 and 1638, respectively. The link to download the song or performance is shown as 1640, as well as links to invite friends (1642) and to send to a friend (1644). The name of the actual physical venue in which the performance is taking place “The Iron Horse” is shown as element 1652, and the location “Chicago, Ill.” is shown as element 1634. Participants are also identified in participant block 1650. Also, the users can discuss, via associated avatars, information about the performers, or other topics of interest.

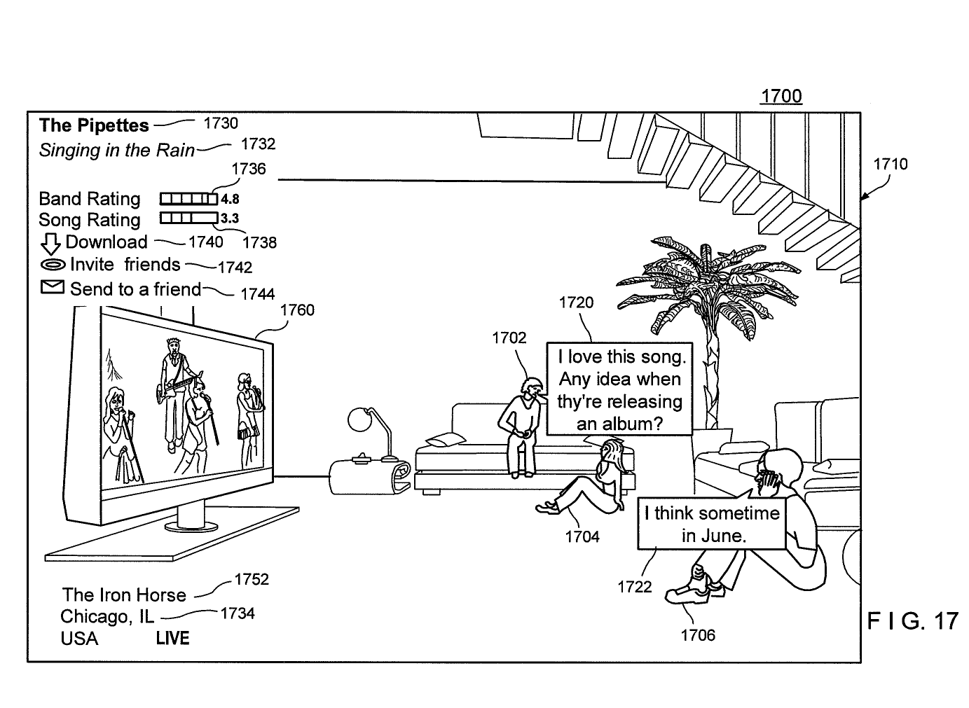

FIG. 17 shows another virtual environment 1700 of virtual room 1710, which provides a virtual place for the avatars 1702, 1704 and 1706 to interact while an event is occurring on virtual television screen 1760. Virtual room 1710 is furnished with virtual furniture such as end tables, sofas, plants, stair case and a lamp, which make the virtual room 1710 have a look and feel of an actual room. The avatars 1702 and 1706 are speaking to each other, using text boxes 1720 and 1722, respectively, reflecting a conversation between the users represented by their associated avatars. Virtual television 1760 is showing a performance that the users are viewing at their respective terminals, such as a personal computer. The performance may be a live performance occurring in real time or a selected archived performance. As shown in FIG. 17, the virtual venue 1700 may be furnished differently than the virtual venue of FIG. 16. The music group is identified as “The Pipettes” as shown by element 1730. The title of the song “Singing in the Rain” is shown as element 1732. A band rating and song rating is displayed as 1736 and 1738, respectively. The link to download the song or performance is shown as 1740, as well as links to invite friends (1742) and to send to a friend (1744). The name of the actual physical venue in which the performance is taking place “The Iron Horse” is shown as element 1752, and the location “Chicago, Ill.” is shown as element 1734. Also, the users can discuss, via associated avatars, information about the performers, or other topics of interest.

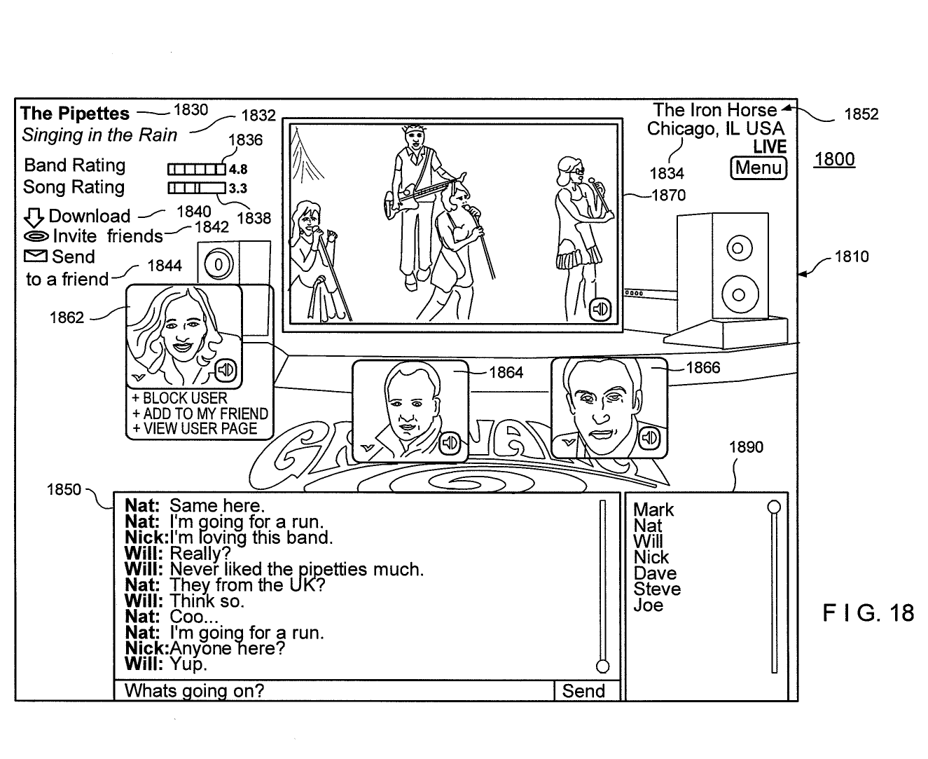

FIG. 18 shows an environment 1800 of virtual room 1810 in which users, each represented by a video image of himself or herself (1862, 1864, 1866), can interact. Each image may be obtained by a camera, located at the user's station, that provides a real time video image of the user. Participants are identified and have an ongoing chat dialog, as shown by element 1850. Participants may also interact with real dialog, by speaking through a microphone located at the user's station, and by listening to other users through speakers or headphones located at the user's station. Virtual screen 1870 is showing a performance that the users are viewing at their respective terminals, such as a personal computer. The performance may be a live performance occurring in real time or a selected archived performance. The music group is identified as “The Pipettes” as shown by element 1830. The title of the song “Singing in the Rain” is shown as element 1832. A band rating and song rating is displayed as 1836 and 1838, respectively. The link to download the song or performance is shown as 1840, as well as links to invite friends (1842) and to send to a friend (1844). The name of the actual physical venue in which the performance is taking place “The Iron Horse” is shown as element 1852, and the location “Chicago, Ill.” is shown as element 1834. A listing of participants is shown in area 1890. Also, the users can discuss information about the performers, or other topics of interest.

It is also an embodiment of the present invention that each viewer present at an event, as represented by an associated virtual identity, such as an avatar, and meeting certain attendance criteria, such as time logged into the event, confirmation of viewing, or other means for confirming that a user viewed an event, is credited with a virtual confirmation of presence at the event. These confirmation credits may be accumulated and used by the user to purchase products and merchandise, such as hats, T-shirts, and furnishings for a virtual venue. The confirmation credits serve to motivate users to select an event and to select additional events in order to acquire additional credit and thereby be entitled to additional promotions.

It is also an embodiment of the present invention that each user present at an event, as represented by an associated virtual identity, receives a virtual data card, such as a virtual ticket stub or band card, related to the event viewed. The card may include photographic data of a band member and other information about the band. The card may also be autographed with an electronic signature by band members and traded to other online users. The card may be displayed at the user's website within the system. Other visitors to the user's website can view the cards displayed there.

It is also an embodiment of the present invention that each user can select and display archived events and corresponding data. The archived event data may be selected from a menu displayed on the client terminal. Selecting a particular archived event will cause the server to stream the selected content to the user terminal. A user may choose a virtual venue, which is typically a private virtual venue to view the event. Similar to the embodiments described above, the user may choose to invite other attendees to view the event.

It is also an embodiment of the present invention that each user can create customized collections of archived songs or videos for retrieval at any time. This is a playlist specific to a particular user and reflects that user's tastes and preferences. The user may generate a collection of favorite songs and define the sequence or order of the songs. This listing of songs will also be available to other visitors to the user's website within the system or virtual venue.

It is also an embodiment of the present invention that users, represented by associated virtual identities, can review and purchase archived events and associated virtual or real merchandise. The users can browse virtual merchandise that can be used to furnish a user's virtual home or private virtual venue, as well as virtual clothing for a user's avatar.

An embodiment of the present invention is directed to a system comprising:
at least one memory; and
at least one processor, coupled to the at least one memory, the at least one processor adapted to execute program code for:
   selecting a first event that is currently occurring;
   selecting a first virtual venue;
   displaying the first event at the first virtual venue during the duration of the first event;
   establishing a virtual identity associated with a user at the first virtual venue; and
   interacting with other users at the first virtual venue, each user having a unique associated virtual identity.

Another embodiment of the present invention is directed to the system as described above and further comprising program code for:
selecting a second event;
selecting a second virtual venue; and
displaying the second event at the second virtual venue during the duration of the second event.

Another embodiment of the present invention is directed to the system as described above and further comprising program code for:
inviting one or more additional users to the selected virtual venue; and
admitting additional users into the selected virtual venue, each additional user being represented by a user-selected virtual identity.

Another embodiment of the present invention is directed to the system as described above and further comprising program code for:
allowing each additional user to invite other users, represented by user-selected virtual identities, into the selected virtual venue.

Another embodiment of the present invention is directed to the system as described above and further comprising program code for:
limiting the number of additional users present in a selected virtual venue.

Another embodiment of the present invention is directed to the system as described above and further comprising program code for:
authorizing selected virtual identities to enter a specific virtual venue.

Another embodiment of the present invention is directed to the system as described above and further comprising program code for displaying rating data at the event.

Another embodiment of the present invention is directed to the system as described above and further comprising program for:
requiring authorization for other users to be admitted to the selected virtual venue.

Another embodiment of the present invention is directed to the system as described above and further comprising program code for:
removing undesired virtual identities from a selected virtual venue.

Another embodiment of the present invention is directed to the system as described above and further comprising program code for:
selecting a subsequent event;
accessing the subsequent event; and
displaying the subsequent event at the selected virtual venue.

Another embodiment is directed to a method comprising:
providing a first event that is currently occurring;
providing a first virtual venue in which the first event is occurring;
providing the first event at the first virtual venue during the duration of the first event;
establishing one or more virtual identities associated with one or more users; and
transmitting program content that includes the first event, the first virtual venue and virtual identities of one or more users to one or more remote locations.

Another embodiment of the present invention is directed to the method as described above and further comprising:
providing a second event;
providing a second virtual venue; and
transmitting program content that includes the second event at the second virtual venue during the duration of the second event to one or more remote locations.

Another embodiment of the present invention is directed to the method as described above and further comprising:
inviting one or more users to the selected virtual venue; and
admitting additional users into the selected virtual venue, each additional user being represented by a user-selected virtual identity.

Another embodiment of the present invention is directed to the method as described above and further comprising:
allowing each additional user to invite other users, represented by user-selected virtual identities, into the selected virtual venue.

Another embodiment of the present invention is directed to the method as described above and further comprising:
limiting the number of additional users present in a selected virtual venue.

Another embodiment of the present invention is directed to the method as described above and further comprising:
authorizing selected virtual identities to enter a specific virtual venue.

Another embodiment of the present invention is directed to the method as described above and further comprising receiving rating data for a selected event from one or more users.

Another embodiment of the present invention is directed to the system wherein the other users require authorization to be admitted to the selected virtual venue.

Another embodiment of the present invention is directed to the method as described above and further comprising:
accumulating the rating data; and
transmitting the rating data to one or more remote locations.

Another embodiment of the present invention is directed to the method as described above and further comprising:
removing undesired virtual identities from a selected virtual venue.

Another embodiment of the present invention is directed to the method as described above and wherein the selected virtual venue is user-customizable, representing particular characteristics.

Another embodiment of the present invention is directed to the method as described above and wherein the particular characteristics comprise size and virtual décor.

Another embodiment of the present invention is directed to the method as described above and further comprising:
providing a subsequent event; and
providing the subsequent event to one or more remote locations.

Another embodiment of the present invention is directed to the method as described above and further comprising:
obtaining merchandise purchase data relating to a particular performer;
comparing the merchandise purchase data to a predetermined threshold; and
setting a flag when the merchandise purchase data indicates that the predetermined threshold has been exceeded.

Another embodiment of the present invention is directed to the method as described above and further comprising:
obtaining entertainment purchase data for a particular performer;
comparing the entertainment purchase data to a predetermined threshold; and
setting a flag when the entertainment purchase data indicates that the predetermined threshold has been exceeded,

Another embodiment is direct to an apparatus comprising:
means for providing a first event that is currently occurring;
means for providing a first virtual venue in which the first event is occurring;
means for providing the first event at the first virtual venue during the duration of the first event;
means for establishing one or more virtual identities associated with one or more users; and
means for transmitting program content that includes the first event, the first virtual venue and virtual identities of one or more users to one or more remote locations.

Another embodiment of the present invention is directed to the apparatus as described above and further comprising:
means for providing a second event;
means for providing a second virtual venue; and
means for transmitting program content that includes the second event at the second virtual venue during the duration of the second event to one or more remote locations.

Another embodiment of the present invention is directed to the apparatus as described above and further comprising:
means for allowing each user to invite other users, represented by user-selected virtual identities, into the selected virtual venue;
means for admitting additional users into the selected virtual venue, each additional user being represented by a user-selected virtual identity.

Another embodiment of the present invention is directed to the apparatus as described above and further comprising:
means for allowing each additional user to invite other users, represented by user-selected virtual identities, into the selected virtual venue.

Another embodiment of the present invention is directed to the apparatus as described above and further comprising:
means for limiting the number of additional users present in a selected virtual venue.

Another embodiment of the present invention is directed to the apparatus as described above and further comprising:
means for authorizing selected virtual identities to enter a specific virtual venue.

Another embodiment is directed the apparatus as described above wherein the other users require authorization to be admitted to the selected virtual venue.

Another embodiment of the present invention is directed to the apparatus as described above and further comprising means for receiving rating data for a selected event from one or more users.

Another embodiment of the present invention is directed to the apparatus as described above and further comprising:
means for accumulating the rating data; and
means for transmitting the rating data to one or more remote locations.

Another embodiment of the present invention is directed to the apparatus as described above and further comprising:
means for removing undesired virtual identities from a selected virtual venue.

Another embodiment of the present invention is directed to the apparatus as described above and wherein the selected virtual venue is user-customizable, representing particular characteristics.

Another embodiment of the present invention is directed to the apparatus as described above and wherein the particular characteristics comprise size and virtual décor.

Another embodiment of the present invention is directed to the apparatus as described above and further comprising:
means for providing a subsequent event; and
means for providing the subsequent event to one or more remote locations.

Another embodiment of the present invention is directed to the apparatus as described above and further comprising:
means for obtaining merchandise purchase data relating to a particular performer;
means for comparing the merchandise purchase data to a predetermined threshold; and
means for setting a flag when the merchandise purchase data indicates that the predetermined threshold has been exceeded.

Another embodiment of the present invention is directed to the apparatus as described above and further comprising:
means for obtaining entertainment purchase data for a particular performer;
means for comparing the entertainment purchase data to a predetermined threshold; and
means for setting a flag when the entertainment purchase data indicates that the predetermined threshold has been exceeded.

It will be appreciated from the above that the invention may be implemented as computer software, which may be supplied on a storage medium, or via a transmission medium such as a local area network or a wide area network, such as the Internet.

Yet another embodiment of the present invention is directed to a virtual tipping feature, which replicates tipping in an actual social club environment. For example, when a band plays in a venue, the band may pass around a hat (or bucket), and viewers, or users, can tip the band a desired amount of money. Tipping is a show of appreciation by the viewer, or user and that the viewer enjoyed the show, or performance. Thus, in virtual rooms of the present invention, there is an option to tip the band being viewed. The amount of the tip will be deducted from the credits in a viewer's account, or a viewer making a tip will be asked to purchase more credits if the viewer has insufficient credits. The tipping amount will be totally anonymous to others, so no other users will know if or how much any other user is tipping. However, the band can access a list of which users tipped them, and the amount of the tip.

Although illustrative embodiments of the invention have been described in detail herein with reference to the accompanying drawings, it is to be understood that the invention is not limited to those precise embodiments, and that various changes and modifications can be effected by one skilled in the art without departing from the scope and spirit of the invention as defined in the appended claims.

What is claimed is:

1. A method comprising:
selecting a first event that is currently occurring;
selecting a first virtual venue;
displaying the first event at the first virtual venue during the duration of the first event;
establishing a virtual identity associated with a user at the first virtual venue; and
interacting with other users at the first virtual venue, each user having a unique associated virtual identity.

2. The method of claim 1 wherein the first virtual venue is available to other virtual identities associated with other users.

3. The method of claim 1 further comprising:
selecting a second event;
selecting a second virtual venue; and
displaying the second event at the second virtual venue during the duration of the second event.

4. The method of claim 1 further comprising:
inviting one or more additional users to the selected virtual venue; and
admitting additional users into the selected virtual venue, each additional user being represented by a user-selected virtual identity.

5. The method of claim 4 further comprising:
allowing each additional user to invite other users, represented by user-selected virtual identities, into the selected virtual venue.

6. The method of claim 1 further comprising:
limiting the number of additional users present in a selected virtual venue.

7. The method of claim 1, further comprising:
authorizing selected virtual identities to enter a specific virtual venue.

8. The method of claim 1, wherein each user transmits rating data for a selected event.

9. The method of claim 8 wherein the rating data is displayed at the event.

10. The method of claim 5 further comprising:
wherein the other users require authorization to be admitted to the selected virtual venue.

11. The method of claim 1 further comprising:
removing undesired virtual identities from a selected virtual venue.

12. The method of claim 1 wherein the selected virtual venue is user-customizable, representing particular characteristics.

13. The method of claim 12 wherein the particular characteristics comprise size and virtual décor.

14. The method of claim 1, further comprising:
selecting a subsequent event;
accessing the subsequent event; and
displaying the subsequent event at the selected virtual venue.

15. An apparatus comprising:
means for selecting a first event that is currently occurring;
means for selecting a first virtual venue;
means for displaying the first event at the first virtual venue during the duration of the first event;
means for establishing a virtual identity associated with a user at the first virtual venue; and
means for interacting with other users at the first virtual venue, each user having a unique associated virtual identity.

16. The apparatus of claim 15 wherein the virtual venue is available to other virtual identities associated with other users.

17. The apparatus of claim 15 further comprising:
means for selecting a second event;
means for selecting a second virtual venue; and
means for displaying the second event at the second virtual venue during the duration of the second event.

18. The apparatus of claim 15 further comprising:
means for inviting one or more additional users to the selected virtual venue; and
means for admitting additional users into the selected virtual venue, each additional user being represented by a user-selected virtual identity.

19. The apparatus of claim 18 further comprising:
means for allowing each additional user to invite other users, represented by user-selected virtual identities, into the selected virtual venue.

20. The apparatus of claim 19 further comprising:
means for limiting the number of additional users present in a selected virtual venue.

21. The apparatus of claim 15, further comprising:
means for authorizing selected virtual identities to enter a specific virtual venue.

22. The apparatus of claim 15, wherein each user transmits rating data for a selected event.

23. The apparatus of claim 22 wherein the rating data is displayed at the event.

24. The apparatus of claim 19 further comprising:
wherein the other users require authorization to be admitted to the selected virtual venue.

25. The apparatus of claim 19 further comprising:
means for removing undesired virtual identities from a selected virtual venue.

26. The apparatus of claim 19 wherein the selected virtual venue is user-customizable, representing particular characteristics.

27. The apparatus of claim 26 wherein the particular characteristics comprise size and virtual décor.

28. The apparatus of claim 19, further comprising:
means for selecting a subsequent event;
means for accessing the subsequent event; and
means for displaying the subsequent event at the selected virtual venue.
